(19) United States
(12) Patent Application Publication
(10) Pub. No.: US 2025/0067006 A1
(43) Pub. Date: Feb. 27, 2025

(54) ARTIFICIAL TURF SEAM CONSTRUCTION SYSTEM

(71) Applicant: Turf Brands, LLC, Stuart, FL (US)

(72) Inventor: James Walton, Hobe Sound, FL (US)

(21) Appl. No.: 18/811,208

(22) Filed: Aug. 21, 2024

Related U.S. Application Data
(60) Provisional application No. 63/578,114, filed on Aug. 22, 2023.

(51) Int. Cl. E01C 13/08; B62B 1/02; B62B 1/26; B62B 5/06

(52) U.S. Cl. CPC E01C 13/08; B62B 1/02; B62B 1/264; B62B 5/06; B62B 2202/025

(57) ABSTRACT

An artificial turf having a seam that approximates a sine wave, preferably a wave with a peak-to-peak distance of twelve inches and an amplitude of 1.4375 inches according to a preferred algorithm to form a wave that is repeated continuously along the length of the turf, producing a scalloped edge. An equation is provided to specify the exact measurements and the application to the turf edge, providing a precise choice of amplitude and periodicity to match the turf beds. The use of the sine seam is virtually invisible, creating a contiguous turf surface. The precision cut allows the turf fibers to perfectly eliminate any visible junction between pieces.

### PRIORITY CLAIM

In accordance with 37 C.F.R. 1.76, a claim of priority is included in an Application Data Sheet filed concurrently herewith. Accordingly, the present invention claims priority to U.S. Provisional Patent Application No. 63/578,114, entitled “ARTIFICIAL TURF SEAM CONSTRUCTION SYSTEM,” filed Aug. 22, 2023. The contents of the above referenced application is incorporated herein by reference.

### FIELD OF THE INVENTION

The invention is directed to artificial turf installation and, in particular, to an improved seam joiner system that reduces installation time and minimizes seam appearance.

### BACKGROUND OF THE INVENTION

Artificial turf, commonly referred to as synthetic turf or astroturf, has gained popularity for numerous reasons. Synthetic turf requires minimal maintenance compared to natural grass. There's no need for mowing, watering, fertilizing, or pesticides. This makes it particularly appealing in regions with water shortages or where maintaining a lush lawn is challenging. Given that artificial turf doesn't need water, it helps conserve water resources, especially in drought-prone areas. It also eliminates the need for harmful pesticides and fertilizers that can affect soil and water quality. Artificial turf can be installed in various settings, from residential lawns to commercial spaces, sports fields, rooftop gardens, and more.

Synthetic turf maintains a consistent green appearance throughout the year, regardless of weather conditions. This can be especially advantageous in areas with extreme climates where natural grass struggles to thrive. Turf can withstand heavy foot traffic and various types of use, making it suitable for sports fields, playgrounds, and high-traffic areas. It can maintain its appearance and performance for many years, reducing the need for frequent replacement. Synthetic turf doesn't produce pollen, reducing allergy-related issues for individuals who are sensitive to pollen and grass allergens.

High-quality turf closely resembles natural grass and can enhance the visual appeal of outdoor spaces. It can be tailored to suit different styles and designs. For instance, backyards can be turned into putting greens. Or the yards can be converted into zero maintenance yards yet maintain the appearance of a lush green lawn.

Installing artificial turf is generally performed by laying down a crushed stone or base support material using rolls of turf that are as wide as possible to limit the number of seams. The drawback to having turf rolls that are as wide as possible is the weight associated therewith. Conventional turf rolls are manufactured, stored, and shipped as 15 foot long rolls that weigh anywhere from 300 to 800 pounds per roll. Thereby making them difficult to handle, ship, store and install. The use of heavy machine equipment is then required to handle, ship, store, and install artificial turf and that expense is passed onto the customer. Thus it would be advantageous to provide an easier way to handle turf rolls that do not require the use of heavy machine equipment.

It is important to note that the quality of the seaming job greatly influences the overall appearance and durability of the artificial turf installation. Improperly done seams can lead to visible lines, uneven surfaces, and potential separation over time. Seams, which are the joints between two or more pieces of artificial turf, are attached using a combination of adhesive and seaming tape. In a conventional installation, the pieces of artificial turf that need to be joined are slightly overlapped and excess fibers from the edges of the turf are trimmed to create a clean and even seam area.

Seams are the focal point of problems with turf, as an improperly secured seam can be easily detected and detracts from the otherwise natural appearance of the turf. If the area requires multiple pieces of turf, adhesive and seaming tape are used by highly trained individuals to join the pieces together so as to minimize the seam appearance. The goal is for the turf to appear seamless.

Conventionally, a seaming tape is placed underneath the edges of the turf where the seams will be created. The tape should be positioned in the center of the overlap and should run the entire length of the seam. A turf adhesive specifically designed for outdoor use is applied over the seaming tape. Turf adhesive is a specialized glue for outdoor use and is considered relatively expensive. The adhesive is cured by use of a weighted roller drawn along the length of the seam to apply even pressure and ensure proper bonding between the turf and the seaming tape.

The problem with the prior turf applications is the difficulties in making the seam appear seamless. While an individual that is experienced in turf seam attachment can make the seam nearly invisible, even the experienced individual has difficulties in concealing a long straight-line seam.

### SUMMARY OF THE INVENTION

An improvement in artificial turf manufacturing and installation that eliminates the need for large equipment and manpower demands. The use of a sine seam is virtually invisible, creating a contiguous turf surface. The precision cut allows the turf fibers to perfectly eliminate any visible junction between pieces; the turf design having a seam that approximates a sine wave, preferably a wave with a peak-to-peak distance of twelve inches and an amplitude of 1.4375 inches according to a preferred algorithm to form a wave that is repeated continuously along the length of the turf, producing a scalloped edge. An equation is provided to specify the exact measurements and the application to the turf edge providing a precise choice of amplitude and periodicity to match the turf beads.

An objective of the invention is to utilize precision water jet cutting or in manufacturing line cutting tool, to form a sine wave that is repeated continuously along the length of the turf on both sides, producing a scalloped edge on both sides of the turf panel, thereby making the joining of turfs virtually invisible, and creating a contiguous turf surface.

Another objective of the invention is to teach an improved method of turf installation using turf rolls specifically sized to 50-100 lbs. to remove the need for cranes, large crews, and massive trucks; allowing use of specialized lift trucks with carpet pole attachments to handle the product.

Another objective of the invention is to teach the use of a turf dolly that allows for ease of moving and unrolling of turf rolls.

Another objective of the invention is to teach a continuous edge in sine wave pattern. The use of the sine seam is virtually invisible, creating a contiguous turf surface. The precision cut allows the turf fibers to perfectly eliminate any visible junction between pieces. The use of the sine seam reduces seam joining time by almost 50 percent as compared to conventional straight-line seams with superior aesthetic results. Peel and stick seam tape eliminates the need for the expensive glue used in conventional seam joining.

Another objective is to teach the use of a geo grid system that allows for easier grading, base stabilization, and better drainage. By use of the geo grid system, a reduction of 50 percent of the base material due to the stabilization effect on the geo grid is expected, which eliminates the need for compacting.

An advantage of the invention is to minimize waste by teaching the method of more efficient laying out of turf panels to cover an area given the smaller roll sizes used to cover irregularly shaped landscape areas.

Another advantage of the invention is the packaging of the product so that it is palletized and easily handled in a conventional distribution and transportation environment as opposed to an irregular, oversized cargo requiring special handling. This is an advantage which eliminates buying or renting specialized equipment such as forklifts, cranes, large trucks, or large warehouses to handle the conventional bulky turf rolls.

Other objectives and advantages of this invention will become apparent from the following description taken in conjunction with any accompanying drawings wherein are set forth, by way of illustration and example, certain embodiments of this invention.

### BRIEF DESCRIPTION OF THE DRAWINGS

FIG. 1 is an exemplary view of aligning the continuous scalloped edges in a sine wave pattern to form an undulating sine wave pattern seam of the present invention;

FIG. 2 is a perspective view of a continuous edge in sine wave pattern on a first artificial turf and a continuous edge in sine wave pattern on a second artificial turf to form a seam in an undulating sine wave pattern;

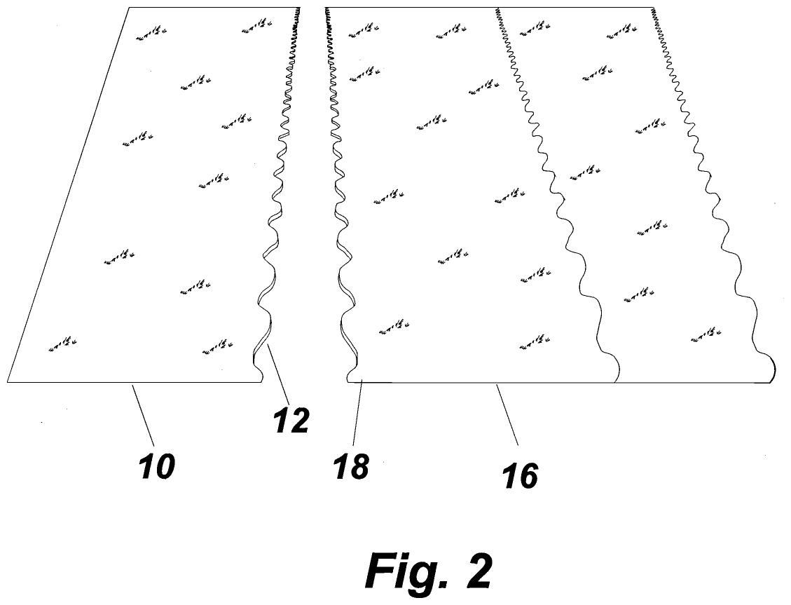

FIG. 3 is a perspective view of applying a base material atop the geo grid system;

FIG. 4 is a perspective view of unrolling a first artificial turf having a continuous edge in sine wave pattern;

FIG. 5 is a perspective view of preparing the interlocking and securing of the artificial turf in an undulating sine wave pattern;

FIG. 6 is a side view of a turf dolly; and

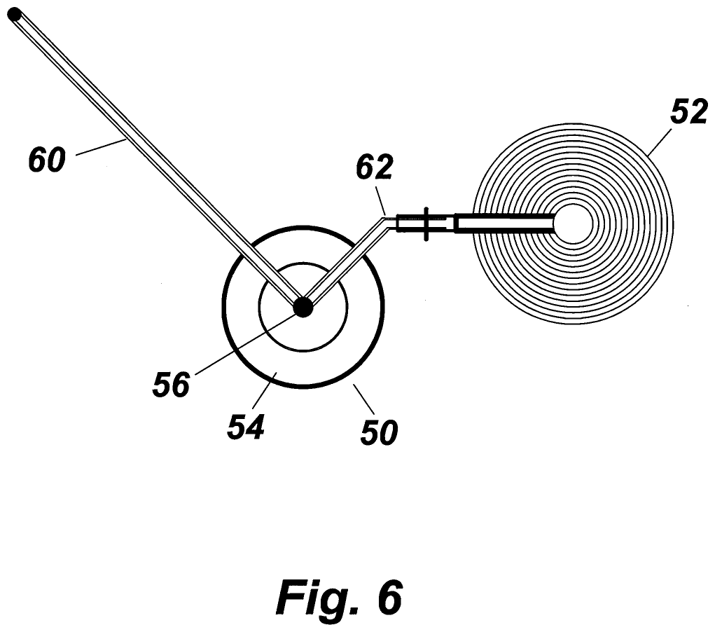

FIG. 7 is a top view of the turf dolly of the present invention.

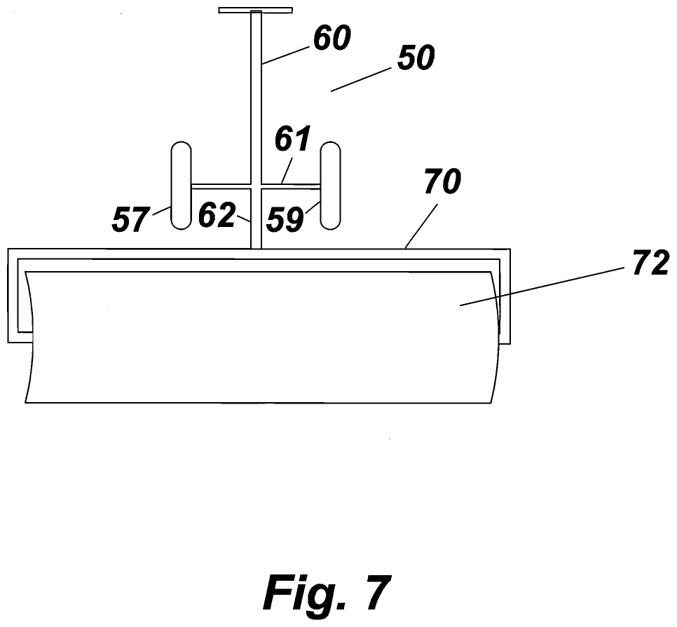

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

The invention is s directed to improvements in the installation of artificial turf and, in particular, to a seam that approximates a sine wave or sine curve. The use of the sine seam is virtually invisible, creating a contiguous turf surface. The precision cut allows the turf fibers to perfectly eliminate any visible junction between pieces.

Referring to the figures in general, the sine wave is depicted in the various figures, relying upon an equation to produce a wave with a peak-to-peak distance of twelve inches and an amplitude of 1.4375 inches according to a preferred algorithm to form a wave that is repeated continuously along the length of the turf edges, producing a scalloped edge; however any peak-to-peak distance or amplitude distance is contemplated. The equation allows the installer to specify the exact measurements and the application to the turf edge as detailed. The uniqueness comes from the precise choice of amplitude and periodicity to match the turf beds, as well as the application to the turf industry. In order to achieve the precise choice of amplitude and periodicity water jet cutting is utilized. By utilizing water jet cutting the turf edge is provided with superior edge quality and precision. The water jet cutting is advantageous because it allows for precise cutouts.

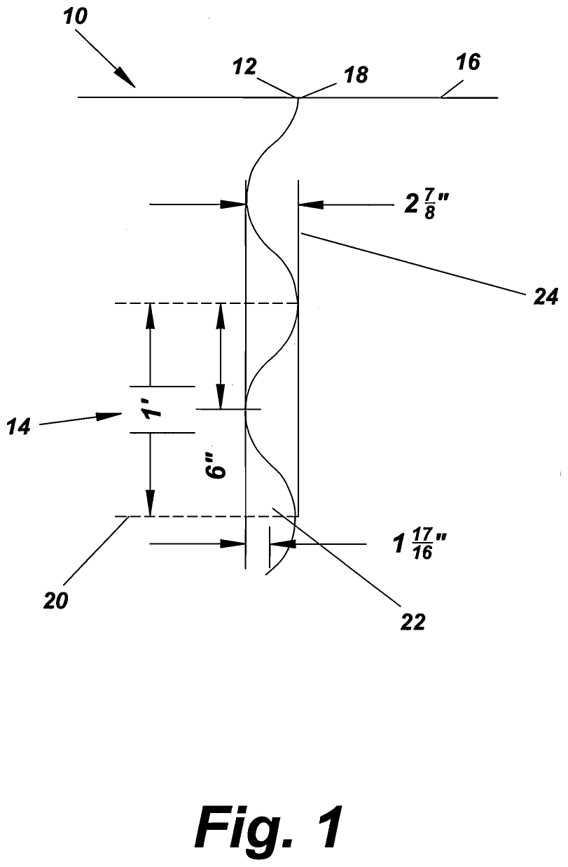

FIG. 1 depicts a first section 10 having a scalloped edge 12 along a section of 12 inches adjoining a second section 16 having a matched scalloped edge 18 forming a continuous scalloped edges in a sine wave pattern to form an undulating sine wave pattern. The generic equation for a sine wave is: y(t)=Asin (B(t-C))+D wherein: A is the amplitude defined as half the height from peak 20 to trough 22 A=1.4375 (1 7/16″) in the preferred embodiment; B determines the periodicity, defined as how frequently the wave peaks; C is a horizontal shift; and D is a vertical shift, D=0 which is measured from a centerline and preferably has no vertical shift. From the height of the peak 20 to the bottom of the wave 24 is 2.875 inches or 2⅞ inches.

In a preferred embodiment the period of a sine wave is given by 2π/B. Since the periodicity from peak to peak is twelve inches: 2π/B=12; B=n/6. The equation for the sine curve on the turf edge will be: y(t)=1.4375 sin (π/6).

This equation will produce a wave with a peak-to-peak distance 14 of twelve inches and an amplitude (20-22) of 1.4375 inches, producing a scalloped edge that mates with an adjoining edge. The uniqueness comes from the precise choice of amplitude and periodicity to match the turf beds, as well as the application to the turf industry. A base is fixed, preferably a geo grid system that allows for easier grading, base stabilization, and better drainage is used. By use of the geo grid system, a reduction of 50 percent of the base material is expected, which eliminates the need for compacting. A peel and stick seam tape is used to couple the adjacent edges together, and eliminates the need for glue to hold the edges together. The width of the glue distributes the stress on the seam, which is problematic with a straight-line seam.

In a preferred embodiment, the artificial turf has a shaped edge comprising a sine wave shape according to the equation: y(t)=1.4375 sine (π/6) to produce a wave with a peak-to-peak distance of twelve inches and an amplitude of 1.4375 inches continuously along the length of the turf, producing a scalloped edge that is placed adjacent an adjoining sine wave shape. The sine wave is constructed and arranged to provide enhanced seam strength, stability, and reduced visibility due to the naturally curving appearance. The seam between two adjoining sections is secured by interlocking the undulating pattern of the sine wave edges.

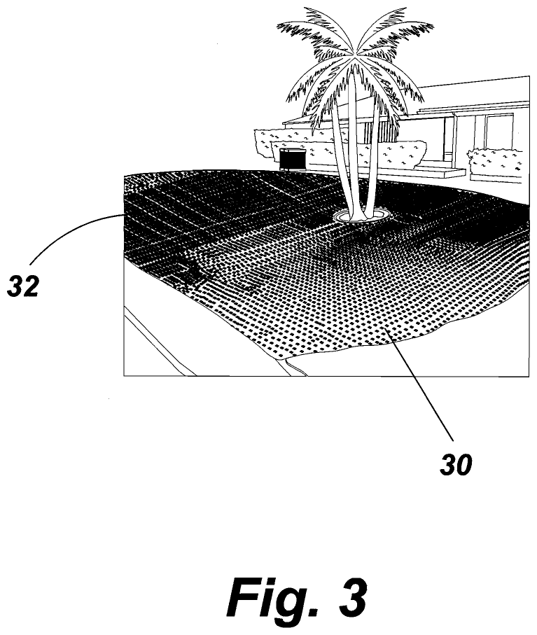

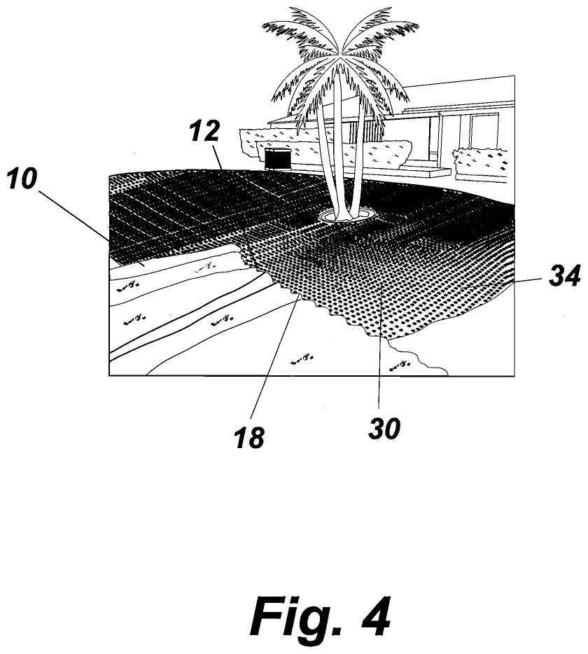

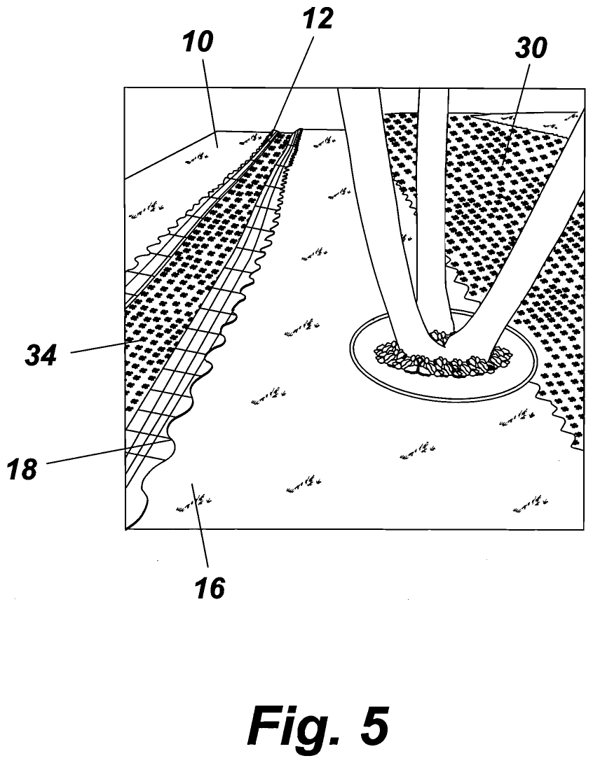

FIG. 3 is a perspective view of laying down a geo grid system 30 on a ground surface 32. FIG. 4 is a perspective view of applying a base material 34 atop the geo grid system 30. FIG. 5 is a perspective view of unrolling a first artificial turf 10 having a continuous edge 12 in sine wave pattern. FIG. 5 shows a perspective view of preparing the interlocking and securing of the artificial turf in an undulating sine wave pattern. The turf material is preferably manufactured with the sine wave shape forming a continuous strip, wherein the sine wave shape is reproduced along the length of the strip using techniques including cutting, molding, extrusion, or heat shaping to form the scalloped edge configuration. The scalloped edge 12, 18 is integrated into the perimeter of the artificial turf to create a visually appealing and seamlessly blended transition between the turf and surrounding surfaces.

The scalloped edge has an amplitude and periodicity that can be adjusted to achieve varying scalloped edge configurations, allowing customization to suit different aesthetic preferences and functional requirements. Manufacturing techniques allow ease of quality control for inspecting the manufactured scalloped edge for consistency, accuracy, and proper integration into the artificial turf structure.

By way of example, the installation of the turf includes the unrolling of a first scalloped edge artificial turf and a second scalloped edge artificial turf; aligning scalloped edges of the first artificial turf and the second artificial turf to form a seam in an undulating sine wave pattern; and interlocking and securing the seam by use of an underlying adhesive tape.

The method of installing the artificial turf system begins with determining the parameters for the sine wave shape, including the equation y(t), amplitude, and periodicity, wherein the amplitude is twelve inches and the periodicity is set to achieve a peak-to-peak distance of 1.4375 inches. Then, the artificial turf material with the determined parameters for the sine wave shape is manufactured by precision water jet cutting. In the manufacturing process, the artificial turf material is formed into a continuous strip, wherein the sine wave shape is reproduced along the length of the strip, resulting in a scalloped edge configuration. At the work site, preparation begins with grading the ground and applying the geo grid system. The geo grid system allows for easier grading, base stabilization, and drainage. Additionally, the geo grid system utilizes less base material and does not require compacting. Once the ground is prepped with the geo grid system and filled with base material, a first scalloped edge artificial turf is unrolled atop of the geo grid system, and then a second artificial turf is unrolled. The scalloped edge of the first artificial turf and the scalloped edge of the second artificial turf are then aligned to form a seam in an undulating sine wave pattern. Lastly, the seam is interlocked and secured. Various methods may be used to secure the first and second edges; however, in a preferred embodiment, adhesive tape is used to ensure structural integrity.

A turf dolly 50 is provided and utilized to unroll the artificial turf 52. The turf dolly eliminates the need for cranes, massive trucks, and large crews in delivery and manipulating the large and heavy artificial turf rolls at the work site. The turf dolly 50 is comprised of at least one wheel 54 having an axle 56. In alternative embodiment, two spaced apart wheels 57, 59 having a common axle 61 is provided. A T-shaped handle 60 extending from one side of the axle 56, whereby the handle 60 is approximately 45 degrees from the horizontal plane of the axle 56; an arm 62 extending from the opposite side of the axle, whereby the arm 62 and the handle 60 form a 90 degree angle and the distal end of the arm extends at least beyond the top surface of the wheel to prevent an artificial turf roll from making contact with the ground when transporting; and an adjustable C-shaped turf carrier 70, whereby the C-shaped turf carrier 70 can accommodate various lengths of artificial turf 72, for instance, from a 5 ft. to a 7.5 ft. roll, the C-shaped carrier extends horizontally from the arm 62. When an artificial turf roll 72 is mounted in the carrier 70, the artificial turf roll 72 does not make contact with the ground unless the operator lowers the roll to make contact with the ground for unrolling of the turf. The turf dolly 50 assists in movement of the turf when the turf is not in contact with the ground and also assists in unrolling of the turf once the roll is lowered to the ground. To assist in unrolling the turf roll, the operator raises the T-handle 60, which simultaneously lowers the C-shaped turf carrier 70 so that the turf roll makes contact with the ground. With the turf roll makes contact with the ground the operator can then push the turf dolly forward to unroll the turf.

By utilizing a formed seam in an undulating sine wave pattern using rolls of turf that are as wide as possible to limit the number of seams is no longer necessary. Thus turf rolls that are manufactured are smaller and weigh less as they do not need to be in excess of 15 feet. Because the turf rolls are smaller in width is allows ease in packaging. Conventional turf rolls were too larger to fit on a pallet. The turf rolls of the present invention are sized to fit on a standard pallet. Additionally, the smaller turf rolls do not require the use of heavy machine equipment to handle, ship, store, and install. Instead a turf dolly is relied upon to ease the operator in handling and installing the artificial turf rolls.

The term “coupled” is defined as connected, although not necessarily directly, and not necessarily mechanically. The use of the word “a” or “an” when used in conjunction with the term “comprising” in the claims and/or the specification may mean “one,” but it is also consistent with the meaning of “one or more” or “at least one.” The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements, possesses those one or more steps or elements, but is not limited to possessing only those one or more elements. Likewise, a step of a method or an element of a device that “comprises,” “has,” “includes” or “contains” one or more features, possesses those one or more features, but is not limited to possessing only those one or more features. Furthermore, a device or structure that is configured in a certain way is configured in at least that way, but may also be configured in ways that are not listed.

One skilled in the art will readily appreciate that the present invention is well adapted to carry out the objectives and obtain the ends and advantages mentioned, as well as those inherent therein. The embodiments, methods, procedures, and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. Artificial turf having at least one shaped edge comprising a sine wave shape according to the equation: y(t)=1.4375 sin (π6) to produce a wave with a peak-to-peak distance of twelve inches and an amplitude of 1.4375 inches continuously along the length of the turf, producing a scalloped edge.

2. The artificial turf of claim 1, wherein said at least one edge approximating a sine wave is configured to provide enhanced seam strength, stability, and reduced visibility due to the naturally curving appearance.

3. The artificial turf of claim 1, wherein the at least one edge approximating a sine wave is utilized to form a seam between two sections of the artificial turf, the seam being secured by interlocking the undulating pattern of the sine wave edges.

4. A method for producing an artificial turf having at least one shaped edge comprising a sine wave shape according to the equation Y(t)=1.4375 sin (π/6), wherein t represents a variable along the length of the turf, the method comprising the steps of:
a) determining the parameters for the sine wave shape, including the equation y (t), amplitude, and periodicity, wherein the amplitude is twelve inches and the periodicity is set to achieve a peak-to-peak distance of 1.4375 inches;
b) manufacturing artificial turf material with the determined parameters for the sine wave shape;
c) forming the artificial turf material into a continuous strip, wherein the sine wave shape is reproduced along the length of the strip, resulting in a scalloped edge configuration;
d) integrating the scalloped edge artificial turf strip into the structure of the artificial turf, aligning the scalloped edge with the desired portion of the turf's perimeter;
e) securing the scalloped edge artificial turf strip to the remainder of the artificial turf using methods including adhesive tape to ensure structural integrity.

5. The method of claim 4 wherein the sine wave shape with the specified parameters is formed using manufacturing techniques selected from cutting, molding, extrusion, or heat shaping to form the scalloped edge configuration.

6. The method of claim 4 wherein the scalloped edge artificial turf strip is integrated into the perimeter of the artificial turf to create a visually appealing and seamlessly blended transition between the turf and surrounding surfaces.

7. The method of claim 4 wherein the amplitude and periodicity of the sine wave shape can be adjusted to achieve varying scalloped edge configurations, allowing customization to suit different aesthetic preferences and functional requirements.

8. The method of claim 4 further comprising the step of quality control, including inspecting the manufactured scalloped edge artificial turf strip for consistency, accuracy of the sine wave shape, and proper integration into the artificial turf structure.

9. A method of claim 4 further comprising the steps of:
f) placing an open grid systems on a ground surface;
g) applying a base material over the open grid system;
h) unrolling a first scalloped edge artificial turf and a second scalloped edge artificial turf;
i) aligning the scalloped edges of the first artificial turf and the second artificial turf to form a seam in an undulating sine wave pattern; and
j) interlocking and securing the seam.

10. A turf dolly for transporting artificial turf compromised of:
at least one wheel having an axle;
a handle extending from one side of the axle, wherein the handle is approximately 45 degrees from a horizontal plane of the axle;
an arm extending from the opposite side of the axle, whereby the arm and the handle form a 90 degree angle and a distal end of the arm extends at least beyond a top surface of the wheel to prevent an artificial turf roll from making contact with a ground surface when transporting; and
an adjustable C-shaped turf carrier, whereby the C-shaped turf carrier can accommodate various lengths of artificial turf; the C-shaped carrier extends horizontally from the arm and, when an artificial turf roll is mounted in the carrier, the artificial turf roll does not make contact with the ground surface.

11. The turf dolly of claim 10, wherein the at least one wheel is two spaced apart wheels having a common axle.

12. The turf dolly of claim 10, wherein the handle is a T-shaped handle.
